(19) United States
(12) Patent Application Publication
(10) Pub. No.: US 2011/0253950 A1
(43) Pub. Date: Oct. 20, 2011

(54) Surface Finishing Product and Method for Its Application

(76) Inventors: Bruce Nash, Phoenix, AZ (US); Harlan Stilwell, Lake Havasu City, AZ (US)

(21) Appl. No.: 12/762,329

(22) Filed: Apr. 17, 2010

(51) Int. Cl. F21V 9/06; B05D 3/10

(52) U.S. Cl. 252/589; 427/301

(57) ABSTRACT

A method includes the steps of preparing a work area for mitigating contamination of an item to be coated. A residue free cleaning solution is applied to a surface of the item for cleaning the surface without leaving residue. The surface is scuffed and cleaned for removing contaminates. The surface rinsed to remove cleaning solution and residue from scuffing the surface. A catalytic hardener is combined with a finishing product comprising clear coat, an accelerated reducer, a fast reducer, an acetone and a UV inhibitor for bonding to the surface with UV protection. The surface is tacked-off to remove dirt and dust. The combined catalytic hardener and finishing product is applied with an HVLP spray system having less than 5 psi of pressure for mitigating overspray. A period of time is provided for the combined catalytic hardener and finishing product to cure.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to surface finishes. More particularly, the invention relates to an environmentally conscious finishing product for protecting and restoring painted or otherwise colored surfaces.

### BACKGROUND OF THE INVENTION

There exists a tangible and marketable need for a durable, flexible, quick-drying, long-lasting, environmentally conscious product for providing protection from ultra violet (UV) rays that can be applied to gel coated or painted metal, plastic, fiberglass, sheet molding compound (SMC) , or rubber items by means of spray or brush coating applications. The primary target markets for this type of product are quite diverse. Some target markets may include, without limitation, the marine industry for coating small to medium size private and commercial watercraft such as, but not limited to, power boats, sail boats, jet skis, etc., commercial vehicle fleets such as, but not limited to, delivery vehicles, garbage trucks, etc., heavy equipment and machinery units such as, but not limited to, bulldozers, graders, fork lifts, back hoes, generators, etc., and numerous other opportunities including, but not limited to, commercial signage, golf carts, traffic barricades, portable restrooms, all terrain vehicles, roof tiles, patio decks, stone facings, etc.

UV rays from the sun may cause various types of damage to painted and otherwise colored surfaces such as, but not limited to, fading, peeling, bubbling, etc. When gel coated or pated surfaces suffer from UV damage, these surfaces must be repainted, which can be expensive and time consuming. A clear coat may be applied to the surface to protect it from UV damage. The application of a clear coat mixed with a catalytic hardener is a commonplace process. This type of process lays a coating on the object being sprayed. However, a clear coat is a hard, non-flexible shell like product that, if applied over graphics and decals, may prevent the eventual removal of the graphics and decals without very aggressive sanding or grinding processes. Additionally, a clear coat sits on top of the surface to which it has been applied and relies on adhesion to the underlying paint surface. It is therefore an objective of the present invention to provide a solution for restoring gel coated and painted surfaces and protecting these surfaces from UV damage that is flexible and bonds to the surface rather than sitting on top of the surface.

Currently there are some products available that meet some of the previously described needs; however, these products do not provide a complete solution for addressing these needs. One known product does not include any ingredients for UV protection. This product also dries too quickly, typically in 3 to 5 minutes, which results in a poor final finish with streaking and dry areas as the applicator is generally unable to “keep a wet edge” with progressive passes of the spray gun. Another known product is a soy based product, which makes it environmentally conscious, and is available for purchase in the commercial and retail marketplace. However, this product also lacks any specific ingredient to prevent sun fading of painted surfaces. Furthermore, this product requires a minimum of twenty four to thirty six hours of drying time and is not recommended for use on white and other light colors, as it tends to darken and change the appearance of the original paint color.

In view of the foregoing, there is a need for improved techniques for providing a UV protection and restoration product that is flexible, can be used on surfaces of any color, bonds to the surface, and has a drying time that is long enough for proper application of the product yet not so long as to be inconvenient.

### BRIEF DESCRIPTION OF THE DRAWINGS

The present invention is illustrated by way of example, and not by way of limitation, in the figures of the accompanying drawings and in which like reference numerals refer to similar elements and in which:

Table 1 illustrates an exemplary formula showing the preferred ranges of volumes of individual ingredients for an environmentally conscious, UV protecting finishing product, in accordance with an embodiment of the present invention; and

FIG. 1 is a flowchart illustrating an exemplary application process for an environmentally conscious, UV protecting finishing product, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a method for applying a combined catalytic hardener and finishing product is presented.

In one embodiment a method includes steps for cleaning a surface of the item without leaving residue, steps for removing contaminates, steps for removing cleaning solution and residue from the removing steps, steps for combining a catalytic hardener with a finishing product for bonding to the surface with UV protection and steps for mitigating overspray of the combined catalytic hardener and finishing product.

In another embodiment a method includes the steps of preparing a work area for mitigating contamination of an item to be coated. A residue free cleaning solution is applied to a surface of the item for cleaning the surface without leaving residue. The surface is scuffed and cleaned for removing contaminates. The surface rinsed to remove cleaning solution and residue from scuffing the surface. A catalytic hardener is combined with a finishing product comprising clear coat, an accelerated reducer, a fast reducer, an acetone and a UV inhibitor for bonding to the surface with UV protection. The surface is tacked-off to remove dirt and dust. The combined catalytic hardener and finishing product is applied with an HVLP spray system having less than 5 psi of pressure for mitigating overspray. A period of time is provided for the combined catalytic hardener and finishing product to cure.

In another embodiment a finish product includes clear coat, an accelerated reducer, a fast reducer, an acetone and a UV inhibitor, where, in combination with a catalytic hardener, the finish product bonds to a surface and enables UV protection.

Other features, advantages, and objects of the present invention will become more apparent, and be more readily understood, from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide a finishing product for painted and otherwise colored surfaces. Preferred embodiments protect these surfaces from UV damage. Preferred embodiments also restore sun faded and otherwise environmentally damaged painted and colored surfaces to their original depth and tone of color and restore the original finish to the surface, for example, without limitation, high gloss, satin, eggshell, etc. Preferred embodiments dry completely within fifteen minutes, thus allowing the item to be returned to service quickly. Finishing products according to preferred embodiments may be applied over all surfaces including, but not limited to, over decals, hydraulic hoses, and tires as well as plastic and rubber components. The only surfaces to which preferred embodiments should not be applied are windshields and other areas of glass where clear visibility is paramount. Preferred embodiments are completely clear liquids which do not visibly change or darken lighter colors being restored. Applying preferred embodiments of the present invention to painted and decaled surfaces is far more cost effective than a complete re-paint and decal process and protects the substrate from future sun damage more effectively than a clear coat alone. Preferred embodiments penetrate through existing paint and decal material to effectively bond to the underlying substrate surface (e.g., metal, fiberglass, etc) rather than simply adhering to the painted top surface of the substrate as a clear coat does. Preferred embodiments cure while leaving a durable gloss finish without the “shell like” characteristic of a clear coat, thus enabling graphics and decals to be easily removed at a future date.

Table 1 illustrates an exemplary formula showing the preferred ranges of volumes of individual ingredients for an environmentally conscious, UV protecting finishing product, in accordance with an embodiment of the present invention. The aspects of applying a coating such as a clear coat to a surface are well known by those who are skilled in the art of paint and body repair. The present embodiment incorporates additional ingredients into a commercially available clear coat to enable the product to perform with various beneficial attributes such as, but not limited to, flexibility, UV protection, the ability to bond to surfaces, etc. It does not matter what clear coat is used in the present embodiment as clear coats are available from a multitude of companies including, but not limited to, Sherwin Williams, DuPont, ICI, Sikkens, Matrix, Martin Senor, PPG, Glasurit, etc. In the traditional use of a clear coat, the mixing ratio is always the same and includes four parts of clear coat to one part of hardener and no other ingredients. Any variation from this and the clear coat does not fully cure. In the present embodiment, the clear coat is mixed with two different reducers (AS8 and US5), an acetone and a UV inhibitor to create the finishing product. In alternate embodiments, AS8 may be used as the sole reducer although drying time will be too rapid in hot/dry climatic conditions. In other alternate embodiments, any slow, medium or fast reducer could be substituted for US5 such as, but not limited to, from a temperature range group US1 through US6, but again, dry times will be sometimes adversely affected depending upon prevailing ambient air temperature at the time of application. In the present embodiment the optimal combination for any climate is 2 parts AS8, to 1 part US4 or US5. Once the finishing product is mixed with a hardener, the finishing product displays different attributes than a traditional clear coat and yet still dries to a full cure because of the additional ingredients. AS8 is an accelerated reducer and US5 is a fast reducer. Hardeners include slow, medium and fast temperature ranges which are selected individually according to the prevailing ambient air temperature encountered during the application process. In alternate embodiments other temperature range hardener can be used despite the prevailing ambient air temperature, although optimal results are only achieved when the correct temperature range hardener is selected. The hardener used in the present embodiment is a catalytic hardener or enzyme of a type usually used to catalyze clear coat. Hardeners are a basic catalyst, manufactured by many different companies. Various manufacturer's clear coat hardeners can be used in the present embodiment. For optimal results the appropriate temperature range hardener should be utilized for any given ambient air temperature encountered during the application process. Spot clear coat is a fast drying product diluted with a drying agent. Use of spot clear coat will however tend to result in a dull surface finish. Thus overall or panel clear coat is the optimal product in the formula depicted within this embodiment. In an alternate embodiment a substitute would be to incrementally raise the level of spot clear coat by as much as 50%. This would then require a lesser quantity of AS8 reducer to slow the drying process and the use of a slower temperature range hardener, which in turn would allow for a closer to optimal final finish, with a high gloss rather than a dull appearance. In the present embodiment, the UV inhibitor is preferably 2-Ethylhexyl-p-methoxycinnamatete, which is a full spectrum sun blocker. This provides enhanced protection from future sun fading of painted or gel coated surfaces. In alternate embodiments, different UV inhibitors may be used such as, but not limited to, any type of liquid UV inhibitor utilized in the manufacturing process of any manufacturer's automotive paint or coatings products as well as any type of liquid UV inhibitor utilized in the manufacture of cosmetic and skincare products. The finishing product according to the present embodiment has been awarded an EPA Exemption that enables the product to be applied in an open-air setting due to the unique formulation of the finishing product. 40 CFR Part 63, is an EPA Rule introduced into Law on Jan. 9, 2008. The Rule represents the National Emission Standards for Hazardous Air Pollutants: Paint Stripping and Miscellaneous Surface Coating Operations at Area Sources. This Rule affects all who “spray apply” a coating(s) that contain specific targeted HAP (hazardous air pollutants), at a concentration in excess of 0.1 percent by mass for OSHA defined carcinogens as specified in 29 CFR 1910.1200(d)(4) and compounds of chromium (Cr), lead (Pb), manganese (Mn), nickel (Ni), or cadmium(Cd) at a concentration in excess of 1.0 percent by mass. It has been demonstrated that the finishing product of the present invention contains none of the target HAP defined within 40 CFR Part 63.

Those skilled in the art, in light of the present teachings, will readily recognize that the volume of the batches listed in Table 1 are for illustrative purposes and that batches of any size may be made so long as the ratio of ingredients stays within the acceptable ranges shown.

There are basically two types of clear coat commercially available, panel clear and spot clear. Spot clear coat is typically used to coat small areas of a vehicle, for example, without limitation, the fender or the bumper when a vehicle has sustained minor damage, whereas panel clear coat is used to coat complete vehicles or large surfaces, for example, without limitation, the entire side of a vehicle that has sustained major damage. In the present embodiment, the formula may be used in both small and large applications, and the same results can be achieved by varying the amount of clear coat used. If panel clear coat is used in the formulation of the finishing product, the amount of panel clear coat may be varied by plus or minus 50% to achieve optimal results. if spot clear coat is used in the formulation of the finishing product then optimal results can again be achieved by varying the amount of spot clear coat by plus or minus 25%.

In typical use of the present embodiment, a surface to be treated is prepared with a cleaner. A cleaner that is citrus based and biodegradable is preferably used as it enables a user to mitigate the generation of hazardous waste during the application process. However, other types of cleaners may be used. Then, the appropriate quantity of the finishing product is mixed with an enzyme. This step cannot be skipped as the enzyme acts as a hardener and the finishing product will not cure properly without it and would therefore fail as a durable surface coating. Once mixed, the finishing product with the hardener is spray applied to a surface, preferably with an HVLP (high-velocity, low-pressure) turbine spray system with a cap pressure of less than 5.0 psi. In alternative embodiments other application methods may be used such as, but not limited to, brushing, rolling, pouring and aerosol spray can. Use of an aerosol spray can may not produce an optimal gloss finish. If brushing is employed, best results are obtained from multiple coats applied to achieve a gloss finish. Compressed air systems, as used in traditional spray application processes, do not deliver the desired results as the heavy overspray caused by the higher pressure, typically in excess of 10 psi, dulls the surface finish. In the present embodiment, the finishing product can be used in multiple ways to enhance a surface appearance, to restore color to “like new” and to protect a surface from future sun fade damage. The finishing product can be used for the protection or refinishing of any type of vehicle including, but not limited to, cars, trucks, vans, tractor-trailers, construction equipment, recreational vehicles, motorcycles, boats, recreational watercraft, etc. The finishing product may also be used on stationary items of equipment such as, but not limited to, generators, road signs, refuse containers, mail boxes, garage doors, stone and tile decking, stucco, paver and concrete driveways, stone facades, vinyl and plastic decals and stickers, swimming pools, spackling, concrete and tile flooring, rubber and plastic components, etc.

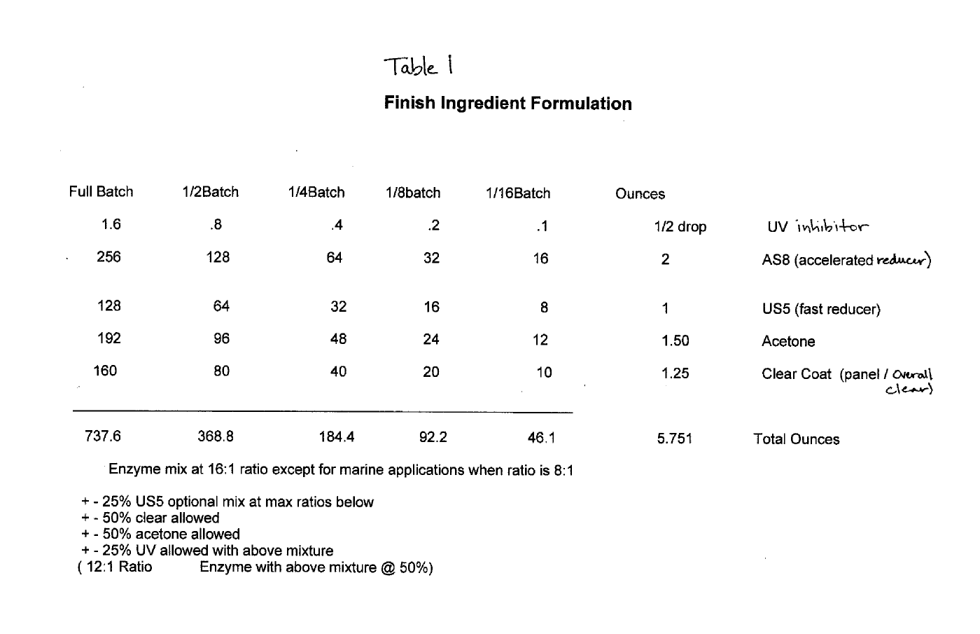

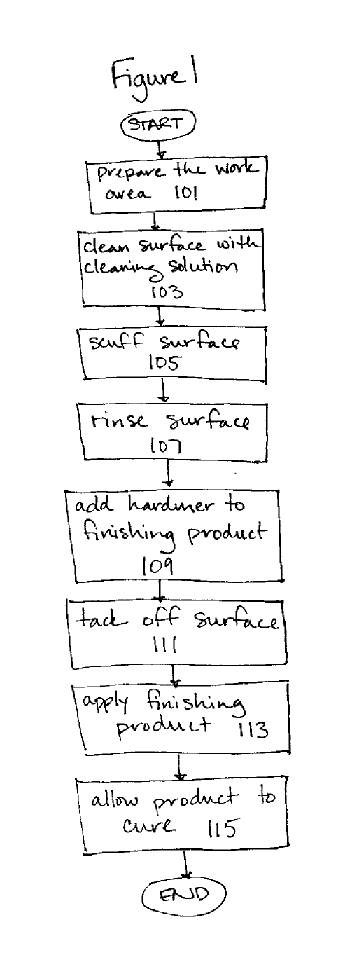

FIG. 1 is a flowchart illustrating an exemplary application process for an environmentally conscious, UV protecting finishing product, in accordance with an embodiment of the present invention. In step 101 the work area is prepared by laying ground tarps in the work area. When possible, the item to be coated should be situated completely on the ground covering in order to minimize any possible ground contamination throughout the cleaning and coating process. In step 103, the surface is cleaned with a cleaning solution that leaves no residue on the surface. The cleaning solution used is preferably a citrus-based, fully biodegradable product which is utilized in part to avoid ground contamination, which may occur with the use of alternative toxic or non-biodegradable cleaners. However, different surface cleaners may be used providing they leave no residue on the surface. In step 105 a gray or gold scuff pad is used to simultaneously scuff and clean the surface to remove all dirt, oils, silicones and other contaminants. When preparing gel coated surfaces, 2000 grit wet/dry sandpaper is preferably used to scuff the surface; however, a gray or gold scuff pad may be used. When using sandpaper, the sandpaper should be completely wet during the scuffing process to generally prevent scratching the surface too aggressively. Only a trained professional should use sandpaper so as to not burn through the painted or gel coated surface. The surface is then thoroughly rinsed with water to completely remove the cleaning solution and any residue in step 107. In step 109 the catalytic hardener is added to the finishing product in the appropriate ratio depending upon the surface type being restored. The ratio is one part catalytic hardener to eight parts finishing product for watercraft surfaces or other types of submerged surfaces and one part catalytic hardener to sixteen parts finishing product for all other surfaces. The catalytic hardener should only be added to the finishing product for activation immediately prior to application of surface coating. The shelf life of the activated finishing product is limited to twenty-four hours to one week depending on various factors including, but not limited to, ambient air temperature and proper sealing of the container. The pot life of the finishing product is in excess of thirty days when stored in a Preval™ spray container that is not opened after filling and after activation. The finishing product produces a high gloss finish; however, non-gloss finishes may be achieved through the addition of a liquid “flattening agent” before applying the product.

In step 111 a tack rag is used to tack-off surface dirt and dust immediately prior to the application process, especially if the surface has been left exposed outdoors or in an enclosed and dusty environment. Results are far superior when the process is conducted outdoors rather than inside a building or spray booth. The activated finishing product is applied to the surface in step 113. The finishing product is preferably applied with an HVLP spray system with less than 5 psi of pressure using a Preval™ spray bottle with a needle/air cap of 1.0-1.3 mm. The finishing product may also be applied with an oil stain brush; however a latex brush or roller is not an acceptable application tool. For the best results, a compressed air spray gun system is not used, as the higher pressure used in this system results in a dulling effect to the final finish. The finishing product dries quickly and overspray developed with the use of overly high pressure systems falls back onto the rapidly drying surface, does not blend in and instead creates dry and dull areas. If a Preval™ spray bottle system is used for application, a broken toothpick is inserted into the pickup tube of the Preval™ spray bottle for the atomization of the finishing product. This is due to the low viscosity of the finishing product. The toothpick is inserted into the pickup tube with the broken end facing upwards and towards the spray valve atomizer. The finishing product is preferably dusted on with the high velocity low pressure HVLP spray gun for a transfer of material as opposed to spraying the product directly on the surface as is typical with regular spray paint application. When applying the finishing product with a brush, optimal results are achieved with the build up of multiple thin coats applied successively and after each prior coat has dried to the touch. Unless the substrate is particularly porous then 3 to 4 coats will provide an optimal resulting finish. In step 115 the finishing product is allowed to cure. The finishing product dries in fifteen minutes, and the item being finished may be returned to service after this time has elapsed. However, coated surfaces should not be pressure washed or cleaned with harsh chemicals for two weeks after application to allow for a completed cure. If necessary, buffing may be performed after three hours of application to remove any light dust particles that may be visible. The use of a blue clay bar and hand glaze is the preferred method for removing this dust. Once the finish is completely cured the process ends.

When using this process for application, no heating method is necessary to obtain best results. Traditional spray application of automotive coatings typically requires heated spray booths or heat lamp assemblies. Also, the application of this finishing product can be legally performed on a mobile basis and in an open-air environment. Generally this is prohibited by EPA Regulations as application of automotive surface coatings are conducted within a controlled environment, such as, but not limited to, a spray booth. Furthermore, no hazardous waste is created during the application process unlike in other types of automotive coating processes.

In various alternate embodiments, the formulation of the finishing product may be adjusted for geographical location and temperature range where the product will be used. For example, but not limited to, temperature ranges would be 0-40 degrees F., 40-60 degrees F., 60-85 degrees F. and 85+degrees F. Humidity and altitude may be factored in by adjusting the quantities of AS8 in each geographic area. In other applications such as, but not limited to, two stage application of base coat and clear coat, a thinner and faster drying formula achieves optimal results with minimal airborne particles left in the finish. It is also contemplated that modified formula of the finish product may be used to repair/replace clear coat damage.

Having fully described at least one embodiment of the present invention, other equivalent or alternative methods of providing an environmentally conscious and UV protecting finishing product according to the present invention will be apparent to those skilled in the art. The invention has been described above by way of illustration, and the specific embodiments disclosed are not intended to limit the invention to the particular forms disclosed. For example, the particular implementation of the finishing product may vary depending upon the particular type of surface being coated. The surfaces described in the foregoing were directed to painted or gel coated surfaces; however, alternate formulations may be implemented for non-painted surfaces such as, but not limited to, raw wood, metal or fiberglass, stained surfaces, powder coated surfaces, etc. Implementations of the present invention for use on non-painted surfaces are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims. What is claimed is:

1. A method comprising:
steps for cleaning a surface of the item without leaving residue;
steps for removing contaminates;
steps for removing cleaning solution and residue from the removing steps;
steps for combining a catalytic hardener with a finishing product for bonding to the surface with UV protection; and
steps for mitigating overspray of the combined catalytic hardener and finishing product.

2. The method as recited in claim 1, further comprising steps for mitigating contamination of an item to be coated.

3. The method as recited in claim 1, further comprising steps for removing dirt and dust from the surface.

4. A method comprising the steps of:
preparing a work area for mitigating contamination of an item to be coated;
applying a residue free cleaning solution to a surface of the item for cleaning the surface without leaving residue;
scuffing and cleaning the surface for removing contaminates;
rinsing the surface for removing cleaning solution and residue from scuffing the surface;
combining a catalytic hardener with a finishing product comprising clear coat, an accelerated reducer, a fast reducer, an acetone and a UV inhibitor for bonding to the surface with UV protection;
tack-off the surface for removing dirt and dust;
apply the combined catalytic hardener and finishing product with an HVLP spray system having less than 5 psi of pressure for mitigating overspray; and
providing a period of time for the combined catalytic hardener and finishing product to cure.

5. The method as recited in claim 4, wherein the residue free cleaning solution comprises a citrus-based and fully biodegradable solution.

6. The method as recited in claim 4, wherein the UV inhibitor comprises 2-Ethylhexyl-p-methoxycinnamatete.

7. The method as recited in claim 4, wherein the accelerated reducer is AS8.

8. The method as recited in claim 7, wherein the fast reducer is US4 or US5.

9. The method as recited in claim 8, wherein the finishing product comprises two parts of accelerated reducer for one part fast reducer.

10. The method as recited in claim 4, wherein the finishing product generally comprises 1.5 parts acetone and 1.25 parts clear coat.

11. The method as recited in claim 4, wherein the clear coat comprises panel clear coat.

12. The method as recited in claim 11, wherein one part catalytic hardener is combined with eight parts finishing product for watercraft surfaces or other types of submerged surfaces, and one part catalytic hardener to sixteen parts finishing product for all other surfaces.

13. A finish product comprising:
clear coat;
an accelerated reducer;
a fast reducer;
an acetone; and
a UV inhibitor, where, in combination with a catalytic hardener, the finish product bonds to a surface and enables UV protection.

14. The finish product as recited in claim 13, wherein the UV inhibitor comprises 2-Ethylhexyl-p-methoxycinnamatete.

15. The finish product as recited in claim 13, wherein the accelerated reducer is AS8.

16. The finish product as recited in claim 15, wherein the fast reducer is US4 or US5.

17. The finish product as recited in claim 16, wherein the finishing product comprises two parts of accelerated reducer for one part fast reducer.

18. The finish product as recited in claim 13, wherein the finishing product generally comprises 1.5 parts acetone and 1.25 parts clear coat.

19. The finish product as recited in claim 13, wherein the clear coat comprises panel clear coat.

20. The finish product as recited in claim 19, wherein one part catalytic hardener is combined with eight parts finishing product for watercraft surfaces or other types of submerged surfaces and one part catalytic hardener to sixteen parts finishing product for all other surfaces.
